(19) United States
(12) Patent Application Publication
(10) Pub. No.: US 2013/0199704 A1
(43) Pub. Date: Aug. 8, 2013

(54) System and Method for Customizing Vehicle Tires on Demand at Point-of-Sale

(71) Applicant: Scott Damon, Brentwood, TN (US)

(72) Inventor: Scott Damon, Brentwood, TN (US)

(21) Appl. No.: 13/758,938

(22) Filed: Feb. 4, 2013

Related U.S. Application Data
(60) Provisional application No. 61/595,969, filed on Feb. 7, 2012.
(60) Provisional application No. 61/595,980, filed on Feb. 7, 2012.
(60) Provisional application No. 61/595,985, filed on Feb. 7, 2012.
(60) Provisional application No. 61/595,987, filed on Feb. 7, 2012.
(60) Provisional application No. 61/595,990, filed on Feb. 7, 2012.
(60) Provisional application No. 61/595,997, filed on Feb. 7, 2012.

(51) Int. Cl. B29D 30/08

(52) U.S. Cl. CPC B29D 30/08
USPC 156/110.1; 156/394.1; 156/350

(57) ABSTRACT

Methods and systems for on demand, customized manufacture of vehicle tires at a point-of-sale are disclosed. At a point-of-sale, tire casings and tire treads that have been manufactured separately to enhance certain performance characteristics are assembled to provide a final customized tire.

### CROSS-REFERENCE TO RELATED APPLICATIONS

This patent application claims the benefit of priority to:

(1) U.S. Provisional Patent Application No. 61/595,969, filed on Feb. 7, 2012, and entitled “System and Method for Decentralized Manufacture of New Tires Enabling Improved Performance Characteristics”;

(2) U.S. Provisional Patent Application No. 61/595,980, filed on Feb. 7, 2012, and entitled “System and Method for Customizing Vehicle Tires on Demand at Point-of-Sale”;

(3) U.S. Provisional Patent Application No. 61/595,985, filed on Feb. 7, 2012, and entitled “System and Method for Reducing Point-of-Sale Tire Inventory”;

(4) U.S. Provisional Patent Application No. 61/595,987, filed on Feb. 7, 2012, and entitled “System and Method for Tracking Inventory of Tire Components at Point-of-Sale Facility”;

(5) U.S. Provisional Patent Application No. 61/595,990, filed on Feb. 7, 2012, and entitled “System and Method for Pricing, Leasing and Transferring Ownership of Tires”; and

(6) U.S. Provisional Patent Application No. 61/595,997, filed on Feb. 7, 2012, and entitled “System and Method for Customizing and Manufacturing Tires Near Point-of-Sale,”

which are incorporated in their entireties herein by this reference.

### BACKGROUND OF THE INVENTION

Pneumatic vehicle tires are used on many forms of vehicles including trucks, buses, construction vehicles and passenger vehicles. Modern pneumatic vehicle tires are constructed of many components that are brought together as the uncured green tire is formed. As shown in FIG. 1, the basic structure of a pneumatic tire may include a crown area (where the tread is located) 10, sidewall areas 20 and bead areas 30. The crown area 10 may include multiple distinct components, such as, steel belts 12, a nylon cap ply 14, a tread 16, etc. The tread 16 also may have associated with it a subtread 17 and an undertread 18. The sidewall areas 20 can include, among other components, a multi-layered body ply 22, an inner liner 24, and a rubber sidewall 26. The bead areas 30 can include a steel bead bundle 32, a bead filler 34, a body ply 22, and an abrasion gum strip 36.

New vehicle tires are usually constructed in a manufacturing process performed at a single manufacturing plant. In general, the green tire is built in an uncured and un-vulcanized manner by assembling the pieces described above. The green tire is then placed in a mold and vulcanized or cured using heat and pressure. This process bonds the tire components together. The completed new tires are generally distributed from the tire manufacturing plant to original equipment manufacturer (“OEM”) vehicle manufacturers, wholesale distribution centers, tire distributors, repair shops, and other points-of-sale.

Because different parts of the tire are constructed using different materials and of different thicknesses, the curing process can effect parts of the tire differently. For example, as shown in FIG. 1, the sidewall area 20 is thinner than the crown area 10. When the tire is cured, the sidewall area can be over-cured, yet the crown area can be under-cured. These departures from a desired curing condition can negatively affect the durability, rolling resistance and other performance characteristics of the tire.

In addition, tires are large items which can require a large inventory space, and there is a vast number of different tire types and models. To ensure that the spectrum of tire choices that a customer may want are on hand, point-of-sale facilities are required to stock large amounts of tires, which results in a large capital investment in inventory and in the storage of the tires in inventory. The large and varied inventory maintained by a point-of-sale facility can lead to additional costs related to the discarding of old tires. As a tire ages in inventory, the tire can lose some of its performance capabilities. Tires only have a certain amount of time, or “shelf life,” within which the tire retains, or is close to, its original performance capabilities. Thus, if a tire shop owner has aging inventory, he may be required to sell the aging inventory at discounted prices and/or discard old tires.

U.S. Patent Application Publication No. US 2009/0203278 is directed to a toroidal body support provided for pneumatic coverings. The body support has rims, side walls and a flat zone as a base for a tread. The body is finished without a tread and includes a peripheral flat zone covered by a removable woven yarn layer having a width that is wider than that of the flat zone to form side edges to assist removal.

U.S. Patent Application Publication No. US 2009/0183812 is directed to a universal body-support for a pneumatic tread which is presented as a finished part for tailored application of any type of tread. The universal body-support includes talons wings and a flat area presenting a bearing area and does not have a tread. The tread has a base layer coated by an elastomeric layer, which is protected against oxidation and contaminants by a film made of removable plastic material or by a braided thread layer.

There is a continued need in the art for systems and methods for producing a tire in a manner that allows for the ready customization of the tire in such a way that the tire is able to perform according to a customer's desired performance characteristics. Furthermore, there is a continued need in the art for systems and methods for producing a tire in a manner that helps reduce the inefficiencies associated with maintaining a large inventory of tires at a point-of-sale facility.

### SUMMARY OF THE DISCLOSURE

In one embodiment, a system for manufacturing tires at a point-of-sale facility is described. A tire casing inventory of a plurality of different types of tire casings is stored at the point-of-sale facility. A tire tread inventory of a plurality of different types of tire treads is stored at the point-of-sale facility. Tire building equipment is disposed at the point-of-sale facility and is adapted to combine a selected type of the tire casings with a selected type of the tire treads to produce a new finished tire having at least one predetermined tire characteristic.

In another embodiment, a method for manufacturing tires upon demand at a point-of-sale location is described. A tire casing inventory of a plurality of different types of tire casings is maintained at the point-of-sale location. A tire tread inventory of a plurality of different types of tire treads is maintained at the point-of-sale location. Customer tire selection information is received at the point-of-sale location. The customer tire selection information includes a tire characteristic. In response to receiving the customer information, tire building equipment at the point-of-sale facility is operated to produce from a tread-casing combination of a selected type of the tire treads and a selected type of the tire casing a new tire having the tire characteristic.

In still another embodiment, a method for manufacturing customized tires upon demand at a point-of-sale location is described. A tire casing inventory of a plurality of different types of tire casings is maintained at the point-of-sale location. A tire tread inventory of a plurality of different types of tire treads is maintained at the point-of-sale location. Customer tire selection information including at least one selected rating corresponding to a performance characteristic of a tire is received at the point-of-sale. Based on the at least one selected rating, a particular type of tire casing is selected from the types of tire casings, and a particular type of tire tread is selected from the types of tire treads. A tire is built at the point-of-sale location using a tread-casing combination including a tread of the selected type and a casing of the selected type.

Further and alternative aspects and features of the disclosed principles will be appreciated from the following detailed description and the accompanying drawings. As will be appreciated, the principles related to systems and methods for customizing and manufacturing tires at the point-of-sale disclosed herein are capable of being carried out in other and different embodiments, and capable of being modified in various respects. Accordingly, it is to be understood that the foregoing general description and the following detailed description is exemplary and explanatory only and does not restrict the scope of the disclosed principles.

### BRIEF DESCRIPTION OF THE SEVERAL VIEWS OF THE DRAWINGS

FIG. 1 is a fragmentary, cut-away perspective view of an exemplary tire.

FIG. 2 is a schematic diagram of an embodiment of a system for customizing and manufacturing tires at a point-of-sale constructed according to principles of the present disclosure.

FIG. 3 is a schematic flowchart of an embodiment of a method for customizing and manufacturing tires at a point-of-sale following principles of the present disclosure.

FIG. 4 is a fragmentary, schematic transverse cross-sectional view of an exemplary tire.

FIG. 5 is a fragmentary, schematic transverse cross-sectional view of an embodiment of a new tire tread constructed according to principles of the present disclosure.

FIG. 6 is a fragmentary, schematic transverse cross-sectional view of an embodiment of a new tire casing constructed according to principles of the present disclosure.

FIG. 7 is a schematic flowchart of steps of an embodiment of a method for customized manufacture of a new tire following principles of the present disclosure.

FIG. 8 is a representative screen display of an embodiment of a graphical user interface of an embodiment of a tire customization system constructed according to principles of the present disclosure.

FIG. 9 is a representative screen display of an embodiment of a graphical user interface of an embodiment of a tire customization system constructed according to principles of the present disclosure.

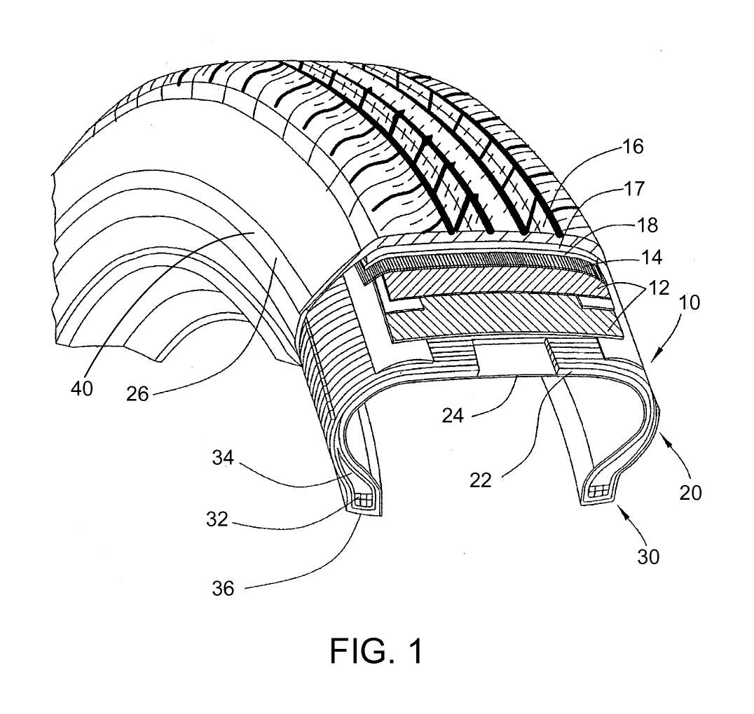

### DETAILED DESCRIPTION OF PREFERRED EMBODIMENTS

In certain aspects, the present disclosure relates to a distributed manufacturing procedure for new tires which includes delivering new tire components to a point-of-sale facility for assembly at the point-of-sale facility into a new tire having certain specified characteristics in response to a customer's tire order. The distributed manufacturing techniques disclosed herein can provide for commercial advantages, such as, cost savings opportunities related to inventory reduction and also can provide technical advantages, such as, providing tires with increased performance characteristics and the ability to offer customers a customizable tire selection choice that can be tailored to meet a set of requirements for the customer's intended use and specific driving requirements.

In an exemplary embodiment, the disclosure describes a method for producing upon demand at a point-of-sale location customized tires built to obtain certain enhanced performance characteristics. The method includes providing and maintaining at a point-of-sale a set of tire casings manufactured without tire treads to provide enhanced performance characteristics, such as improved rolling resistance. A set of tire treads, manufactured without tire casings to provide enhanced performance characteristics, such as tire tread wear and wet traction, are provided and maintained at the point-of-sale. At the point-of-sale location, a specific tire tread and tire casing are selected and combined to form a customized tire for a customer.

In another embodiment, a system for point-of-sale customization of tires built to suit a customer includes a set of new tire casings at a point-of-sale that have been manufactured to enhance selected performance characteristics. The system also includes a set of new tire treads at the point-of-sale, separate from said tire casings, that have been manufactured to enhance selected performance characteristics, such as tire tread wear and wet traction. The system further includes at the point-of-sale a machine capable of assembling a selected tire casing with a selected tire tread to provide a new customized tire. The new customized tire can be customized to meet selected enhanced criteria including at least one of rolling resistance, wear resistance, traction capability under different weather and climate conditions, speed rating, and drive-surface-specific features of the tire, for example.

In another embodiment, a method for producing upon demand at a point-of-sale location customized tires built to emphasize certain enhanced performance characteristics includes providing and maintaining at a point-of-sale a set of tire casings manufactured without tire treads to provide enhanced performance characteristics, such as improved rolling resistance. A set of tire treads, manufactured without tire casings to provide enhanced performance characteristics, are provided and maintained at the point-of-sale. A selected performance characteristic of a final tire is received at the point-of-sale. Based on the selected performance characteristic of the final tire, a tire casing is selected from the set of tire casings and a tire tread is selected from the set of tire treads that together substantially meet the received performance characteristic. A customized tire is built using the selected tire casing and tire tread.

In another embodiment, a system for point-of-sale customization of tires built to suit a customer includes a set of new tire casings at a point-of-sale that have been manufactured to enhance selected performance characteristics. The system also includes a set of new tire treads at a point-of-sale, separate from said tire casings, that have been manufactured to enhance selected performance characteristics, such as tire tread wear and wet traction. The system also includes a computer system adapted to display said performance characteristics of said tire casings and tire treads and adapted to receive a user's selection of a specified casing and a tire tread from a set of tire treads and tire casings based on said performance characteristics. The system also includes at the point-of-sale a machine capable of assembling the selected tire casing with the selected tire tread to provide a new customized tire.

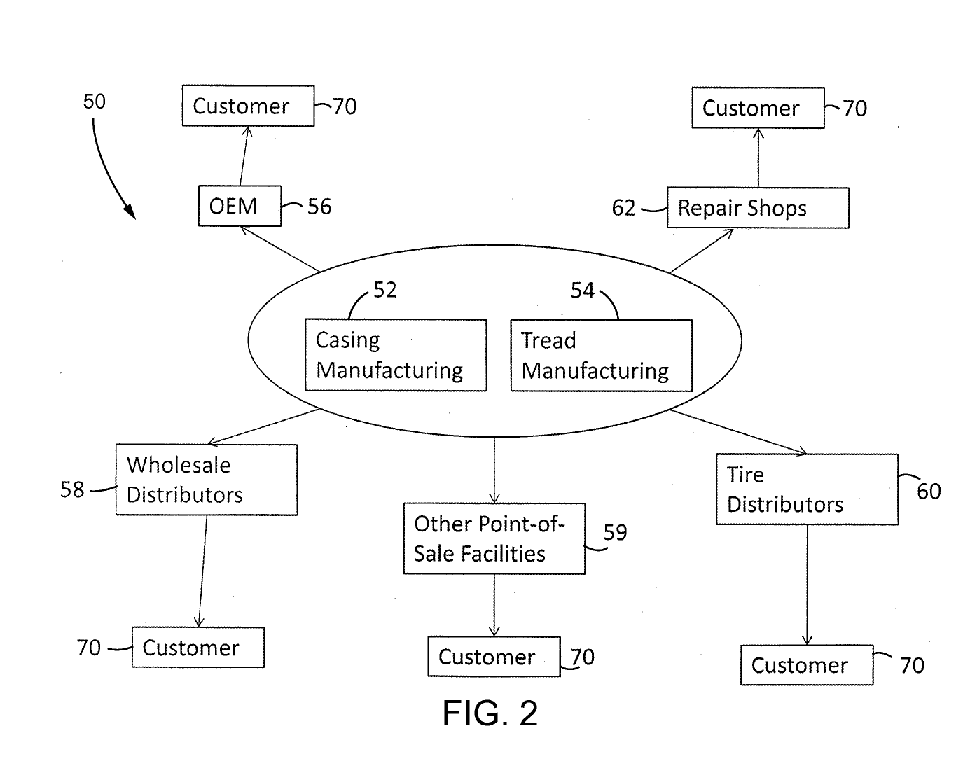

Turning to the Figures, a system 50 for customizing and manufacturing tires at a point-of-sale facility is shown in FIG. 2. Tire casing manufacturing 52 is separate and apart from tire tread manufacturing 54. In some embodiments, tire casing manufacturing 52 can occur at one or more manufacturing facilities which are separate from the manufacturing facility, or facilities, at which the tire tread manufacturing 54 occurs. In other embodiments, one or more manufacturing facilities can be used to carry out separately, the casing manufacture 52 and the tread manufacture 54. The separate manufacture (52, 54) of the casing and tread can allow each to be made using distinct operational steps that enhance the performance characteristics of each component so that when combined to form a new tire, the new tire has enhanced performance ability.

The tire casings 52 and tire treads 54 are distributed to point-of-sale facilities, such as, OEM vehicle manufacturers 56, wholesale distribution centers 58, tire distributors 60, repair shops 62 or other tire point-of-sale facilities 59. At the point-of-sale facility 56, 58, 59, 60, 62, the new tire casings 52 and tire treads 54 are assembled into a new tire in response to a tire order received by the point-of sale facility from a customer 70.

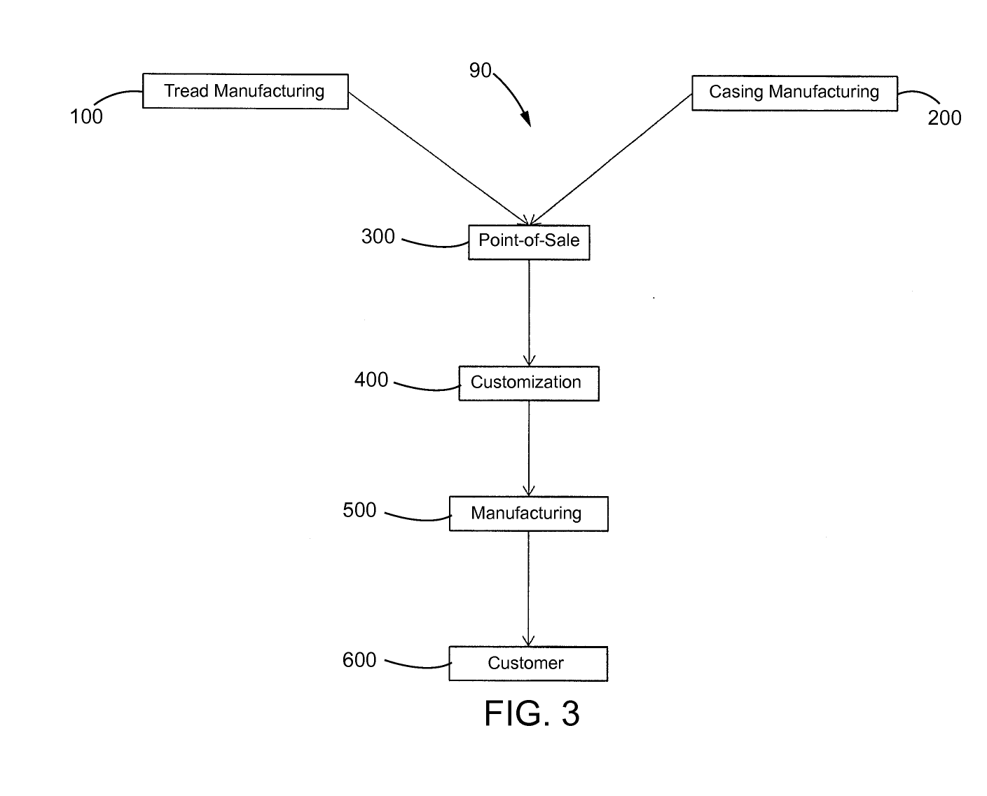

FIG. 3 depicts a flowchart of steps of an embodiment of a method 90 for producing customized tires at a point-of-sale facility following principles of the present disclosure. One or more different types of tire treads are manufactured separate and apart from tire casings (step 100), and one or more different types of tire casings are manufactured separate and apart from tire treads (step 200). The tire treads and tire casings can be manufactured separate and apart from each other to enhance certain performance characteristics. The tire treads and tire casings are delivered to a point-of-sale facility, such as an OEM vehicle manufacturer, a wholesale distribution center, a tire distributor, a repair shop, or other point-of-sale facility (step 300). At the point-of-sale, a customized tire is made by choosing a specific tread and casing combination based on certain performance characteristics and non-performance characteristics (step 400). The selected tire tread and tire casing are then combined to form a new tire (step 500) at the point-of-sale facility which is then transferred to a customer (step 600).

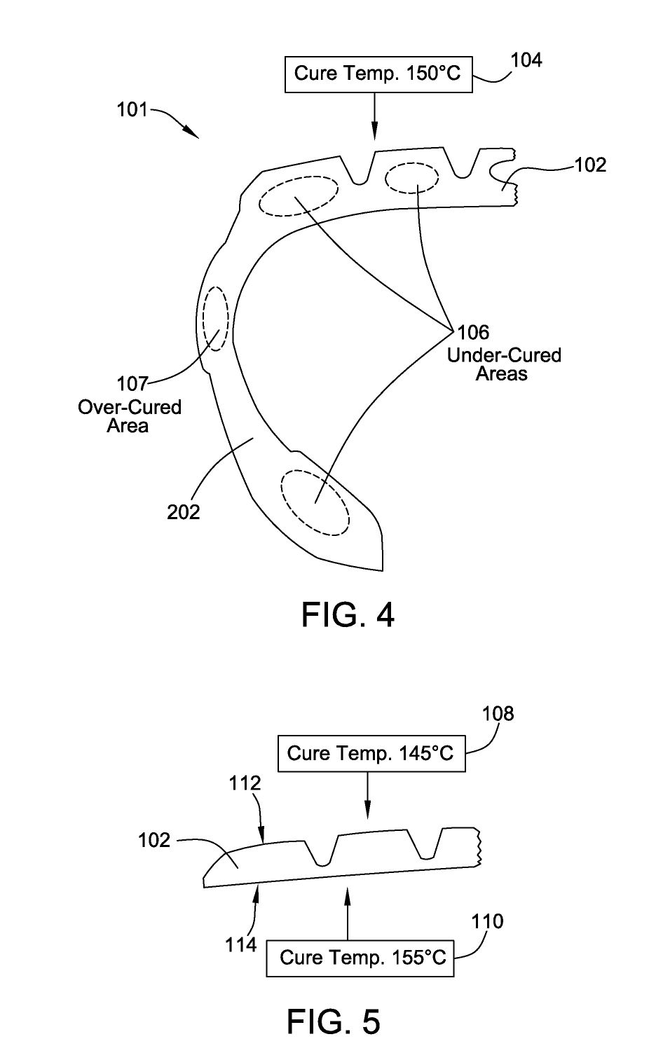

FIG. 4 depicts a schematic transverse cross-section of a tire 101 cured using conventional manufacturing methods. As can be seen in FIG. 4, certain parts of the tire 101 are thinner than other parts of the tire 101. This can result in certain areas 106 of the tire 101 being under-cured and certain areas 107 of the tire 101 being over-cured. In the illustrated tire 101, under-cured areas 106 are present in both the tread 102 and the casing 202, and an over-cured area is shown in the tire casing 202. The over-cured areas 107 and the under-cured areas 106 are exemplary only, and it should be understood that they can occur in other locations, as well. The over-cured areas 107 and/or under-cured areas 106 in the tire 101 can result in reduced performance characteristics, such as, negatively affecting the rolling resistance of the tire 101, for example.

Referring now to FIG. 5, manufacturing the tire tread 102 separate and apart from the tire casing 202 can impart advantages particularly related to the performance characteristics of a tire so made with the separately manufactured tire tread 102 and tire casing 202. One advantage that can be realized by manufacturing tire treads 102 separate and apart from tire casings 202 is that tire treads 102 can be cured using a temperature profile that is different than that used when the curing that tire tread 102 along with a tire casing 202. An example of the negative affects of curing a tire as a single unit that can occur is shown in FIG. 4.

As shown in FIG. 5, when the tread 102 is manufactured separate and apart from the casing 202 (see also, FIG. 3, step 100), the possibility of producing the over-cured areas 107 or the under-cured areas 106 in the tire can be reduced. FIG. 5 shows an example of zoned curing wherein an exterior 112 of the tread 102 is cured at a certain temperature 108 while an interior 114 of the tread 102 is cured at a different temperature 110. In the illustrated embodiment, the curing temperature 108 of the exterior 112 of the tire tread 102 is about 145° C., which is less than the curing temperature 110 of the interior 114 of the tire tread 102 which is about 155° C. In other embodiments, the curing temperatures 108, 110 can be different.

The zoned curing provided by the distributed manufacturing method is an additional advantage to manufacturing tire treads 102 separate from tire casings 202, and it can further reduce the possibility of over-curing or under-curing areas of the tire. This can help to enhance certain performance characteristics of a tire including such a tire tread, including characteristics such as tire durability, tread life, rolling resistance, snow and ice traction, wet traction, fuel usage for highway driving, fuel usage for city driving, and cornering ability.

Tire treads 102 come in a variety of different styles and sizes with a nearly infinite number of different tire tread designs. It will be appreciated, therefore, that in different embodiments, different curing profiles can be used for different types and/or sizes of tire treads to produce the desired performance characteristics.

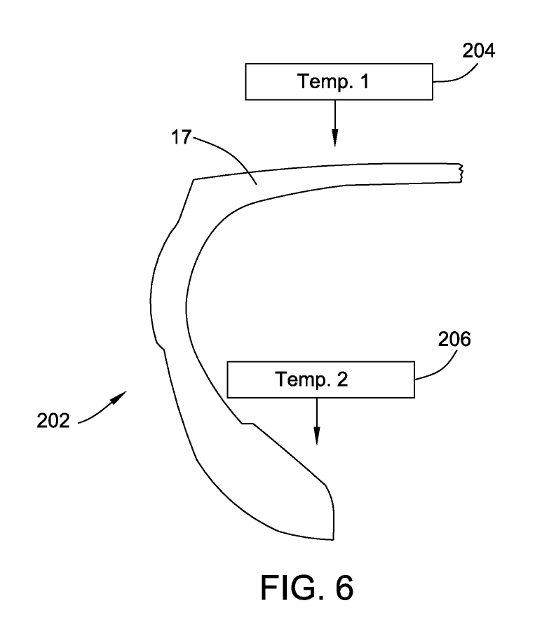

Referring now to FIG. 6, a fragmentary, schematic transverse cross-section of the tire casing 202 is shown. Similar to the manufacture of tire treads 102, tire casings 202 can also be manufactured separate and apart from the tire tread (see also, FIG. 3, step 200). Like the manufacture of the tire treads 102, manufacturing the tire casings 202 separate and apart from the tire treads 102 can allow the manufacturer to enhance certain performance specifications of a tire including such casing. These performance characteristics can include characteristics such as tire durability, casing life, rolling resistance, snow and ice traction, wet traction, fuel usage for highway driving, fuel usage for city driving, cornering ability, and retreadability. Some of these performance characteristics can be increased by using specially designed materials and specially designed configurations of casing components. Additionally, similar to the curing of the tire treads 102 discussed above, some performance characteristics can be increased by the increased ability to cure the tire casing 202 using different curing temperature profiles.

As in the case of the tire tread 102, curing tire casings 202 separate from the tire tread 102 can allow a manufacturer to cure the casing such that over-curing and/or under-curing certain areas of the tire casing 202 can be reduced. Further, curing the tire casings 202 separate from the tire tread can allow the curing profile to be adjusted to have a positive effect on certain performance characteristics of a tire using such a casing.

FIG. 5 depicts an example of curing a casing 202 using different curing temperatures, or zoned curing. In the example shown in FIG. 5, the exterior of the casing 202 is cured at a first temperature 204 while the interior of the casing 202 is cured at a second temperature 206. The first temperature 204 can be different than the second temperature 206 in some embodiments. In embodiments, the curing temperature profile of the casing 202 is different than the curing profile used to cure the tire tread 102 with which it is combined to form a new tire.

Another advantage to manufacturing the treads and casings separate from each other can include decreasing the curing time of each component. Because the amount of material being cured in each component is less and there is a greater ability to zone cure the tread and the casing, curing time for each component can be reduced in some embodiments. This reduction in curing time can allow a manufacturer to produce more tire treads and tire casings in a given amount of time.

In embodiments of the present disclosure, the tire casings are specially manufactured such that the subtread 17 area of the casing is a predetermined thickness that is thicker than what is needed to achieve a tire of a given circumference when bonded to a tread. As discussed in more detail below, the thickness of the subtread 17 is made larger such that the casing can be subjected to a buffing operation to reduce the thickness to accommodate tire treads of differing thicknesses offering customers a greater ability to customize a preferred tire.

Referring to FIG. 3, a plurality of different types of tire treads 102 and tire casings 202 have been manufactured separate and apart from each other (steps 100 and 200) to enhance certain performance characteristics of tires built using these components. They are shipped to point-of-sale facilities (step 300). At the point-of-sale facility, the treads and the casings are preferably stored using an inventory management system such that inventory supplies of each type of tire tread and casing can be monitored and such that a particular tire tread and casing combination can be readily retrieved from inventory to satisfy a customer's tire order at the point-of-sale facility.

To facilitate the customer's selection and customization of a particular tire from the separated tire treads 102 and tire casings 202 at point-of-sale facility (step 400), a customization system 402 can be accessed by the customer 70 to allow the customer 70 to select a tire that is customized for the specific customer's use and is made from a particular combination of a separate tread 102 and casing 202 which are selected from the plurality of types of available treads and casings. The customization system 402 can be configured as a computer system that includes all structures and functionality required to receive and carry out computer executable instructions that are stored on a tangible medium and that are arranged for implementing various functions of the system. The customization system 402 can include a computer system accessible at the point-of-sale and having a processor and tangible storage media with computer executable instructions stored thereon, which are accessible by the processor and at least partially modifiable or configurable by user input and output devices, such as computer terminals.

In some embodiments, the customization system 402 is located at the point-of-sale facility. In other embodiments, the customization system 402, is located off-site from the point-of-sale facility, such as at a central or regional location servicing a plurality of point-of-sale facilities. Each point-of-sale facility can access the customization system 402 through a communication network, such as a web-enabled interface, for example. In such embodiments, the customization system 402 can be accessible by a user from a home computer, from a mobile device, or any other equipment that has an Internet connection or other communication connection adapted to communicate with the customization system 402.

In some embodiments, the customization system 402 includes a user interface. The customization system 402 can allow a customer to select a customized tire in any number of different ways.

In some embodiments, the customization system 402 including a physical computer-readable medium having computer-executable instructions stored thereon and a processor adapted to execute said computer-executable instructions to present a graphical user interface adapted to receive customer selection information and to determine a listing corresponding to tread-casing combinations from the different types of tire casings and the different types of tire treads which produce a tire corresponding to the customer selection information. In embodiments, the customization selection information includes information regarding at least one tire performance characteristic. In embodiments, the customization selection information includes information regarding a selection of at least one of the type of tire tread and the type of tire casing.

In embodiments, each unique tread-casing combination is designated a particular tire identifier. The customization system 402 can be adapted to display a listing of particular tire identifiers that correspond to the customer selection information in the graphical user interface.

The customization system 402 can include a data storage device having stored therein inventory information relating to the number of each of the different types of tire casings 202 in the tire casing inventory and the number of each of the different types of tire treads 102 in the tire tread inventory. The customization system 402 can be adapted to display a listing of particular tire identifiers that correspond to the customer selection information in the graphical user interface, and include a tire tread 102 in the tire tread inventory and a tire casing 202 in the tire casing inventory at the point-of-sale facility. In this way, the customer can be presented with a listing of tire choices that can be filled with on-hand inventory at the point-of-sale facility.

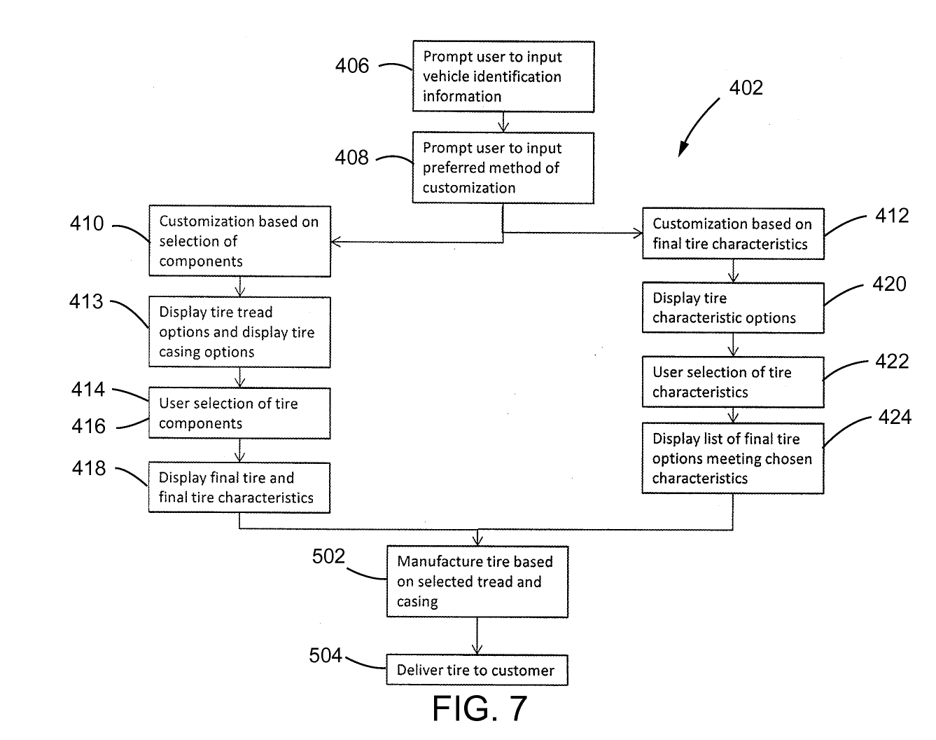

Two methods of selecting a customized tire are depicted in the flow chart of FIG. 7, but many additional methods can be used in other embodiments. As shown in FIG. 7, a customer, using the customization system 402, can be prompted 406 to enter or select general information related to their vehicle such as vehicle make, vehicle model, and/or vehicle manufacturing year. After receiving such basic vehicle information, the customization system 402 can prompt the customer to decide whether the tire should be customized based upon a selection of tire components (casing and tread) 410 or based upon selected performance characteristics of the tire 412.

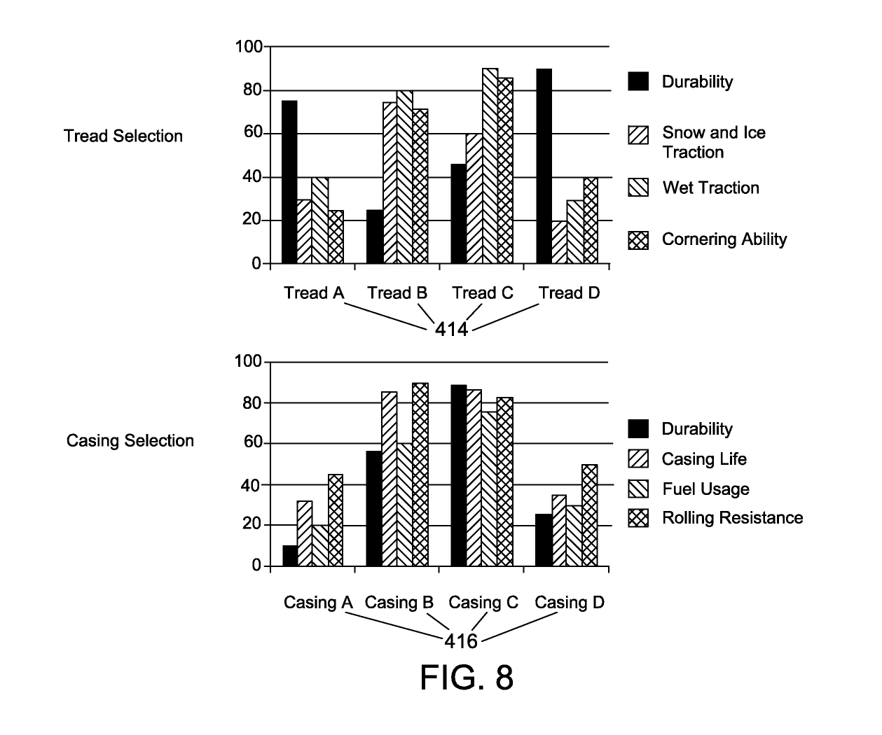

If the user selects to customize a tire by selecting individual components of the tire 412, those components that are present at the point-of-sale and applicable to the customer's specific vehicle may be displayed by the user interface at step 413. An exemplary display screen is shown in FIG. 8. As shown in FIG. 8, a user can be presented with a set of tire tread types each having different performance characteristics. Although only certain tire performance characteristics are shown in FIG. 8, any number of performance characteristics can be displayed by the user interface such as tread durability, tread life, rolling resistance, snow and ice traction, wet traction, fuel usage for highway driving, fuel usage for city driving, and cornering ability. In addition, the user interface can display any number of non-performance characteristics, such as price or tread color. Based on the performance and non-performance characteristics, a user can select a certain type of tread from the set of tread types available at step 414.

Similar to the tire tread selection step 414, a customer can select a tire casing based on certain characteristics. As shown in FIG. 8, a user can be presented with a set of tire casing types each having different performance characteristics. Although only certain performance characteristics are shown in FIG. 8, any number of performance characteristics can be used such as durability, casing life, rolling resistance, snow and ice traction, wet traction, fuel usage for highway driving, fuel usage for city driving, cornering ability, and retreadability. In addition, the user interface can display any number of non-performance characteristics, such as price and color, for example. Based on the performance and non-performance characteristics, a user can select a certain casing from the set of casing types available at step 416.

In some embodiments, the customization system 402 can be adapted to present a subset of types of casings and/or tire treads for selection in the graphical user interface in response to the customer's selected tire tread and/or casing. For example, in such embodiments, a customer's selection of a certain type of tread can de-activate the ability to select certain types of casings based upon the desired performance characteristics sought to be achieved. In embodiments, the customer's selection of a certain type of casing can de-activate the ability to select certain types of tire treads based upon the desired performance characteristics sought to be achieved.

To that end, the customization system 402 can include a data storage device that includes a mapping of the different types of tire treads and casings indexed against a series of tire characteristics to provide one or more possible tire tread-casing combinations to achieved the selected characteristic. The customization system 402 can include a logic module adapted to query the data storage device to determine one or more suitable tire tread-casing combinations to achieve the selected characteristic.

Once the user has chosen a preferred tread and a preferred casing, the user interface can display, for example, a depiction of the final tire and the performance characteristics and non-performance characteristics of the final tire at step 418. The tire can be assembled at the point-of-sale based on the selected tread and casing at step 502, which will be discussed in more detail below.

As described above and referring back to FIG. 7, in other embodiments, the customization system 402 can allow a user to customize a tire based on performance characteristics and non-performance characteristics of the completed tire at step 412. This method of customization can present a user with selectable performance characteristics and non-performance characteristics of a completed tire 420 and the customization system 402 can select the most appropriate tread and casing based on the user's selected tire performance characteristics. The customization system 402 can include a logic module adapted to query the data storage device to determine one or more suitable tire tread-casing combinations to achieve the selected characteristic(s) of the completed tire.

In some embodiments, the graphical user interface can present a checklist of tire characteristics which are available for a new tire. In response to the user selecting one or more characteristics, the customization system 402 can be adapted to present a listing of tires that satisfy the desired characteristics and which can be made from one or more suitable tire tread-casing combinations which are in inventory at the particular point-of-sale facility. The customization system 402 can be adapted to query the inventory management system to determine suitable tire tread-casing combinations.

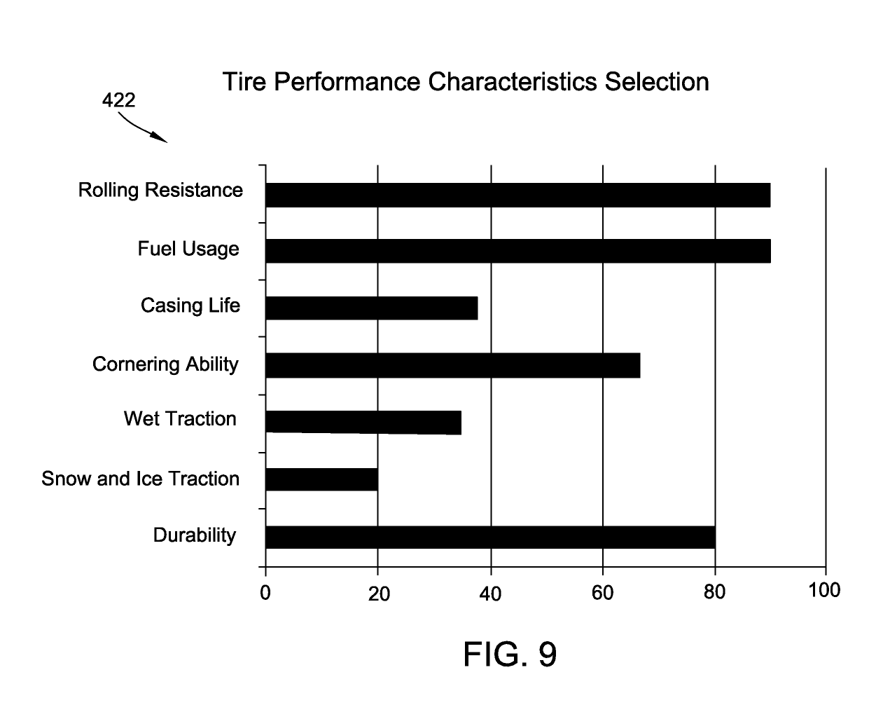

FIG. 9 provides an exemplary display screen of a graphical user interface useful for performing this type of customization. As shown in FIG. 9, a user may be presented at step 420 with certain performance characteristics including, for example, durability, rolling resistance, snow and ice traction, wet traction, fuel usage for highway driving, fuel usage for city driving, cornering ability, and retreadability. In addition, the user interface can include any number of non-performance characteristics, such as price and color.

In embodiments, a user can use the graphical user interface to enter customer preference information relating to the degree of importance the user places on certain characteristics. For example, in the illustrated embodiment, the user can rate the degree of importance of a set of tire characteristics on a scale from zero to one hundred. The customization system 402 can then use the customer preference information it receives to select a tread 102 and a casing 202 combination or combinations that meet or most closely match the user's entered customer preference information.

The customization system 402 can then present the user with a list of final tires and their corresponding characteristics 424. The list of final tires can also be modified based upon the availability of certain tire components at the particular point-of-sale facility. The customer can choose how to rank the tires that are similar to the customer's chosen characteristics. For example, the customer can rank the tires based on closeness to the selected characteristics, price, or any other individual characteristic or subset of characteristics. Once the user is satisfied with a particular tire, the customer can select that tire and the components that make up that tire can be assembled at the point-of-sale facility (see FIG. 7, step 502). The finished, new tire can be delivered to the customer (see FIG. 7, step 504).

In some embodiments, the customer can access the graphical user interface of the customization system 402 through a web-based platform. The customer can custom build a tire as described above. The customer can enter geographical information, which the customization system 402 can be adapted to use to present a listing of closely located point-of-sale facilities which can produce the selected tire for the customer. The tire transaction can be completed through the web-based platform, and the selected point-of-sale facility can be notified of the tire order to commence the tire build.

As previously discussed, the subtread 17 of the casings 202 can be thicker than a subtread of a conventional tire to accommodate tire treads of varying thicknesses. Tire treads can vary in thickness based on certain performance characteristics related to the tread. To ensure that the final tire 502 is the desired overall size for the customer's vehicle, the subtread 17 can be buffed using a buffer to reduce the size of the casing to that necessary to combine the casing with the selected tread and achieve a new tire having a desired outer dimension. Buffing the excess subtread 17 additionally exposes a layer of unoxidized rubber which can promote the seal between the tread 102 and casing 202.

Once the excess subtread 17 has been buffed from the casing 202, the casing 202 is prepared for assembly with the tread 102. In some embodiments an uncured bonding layer or cushion gum is extruded onto the casing surface. The tread 102 is then applied onto the uncured bonding layer and the ends of the tread are spliced together. The selected tread 102 and selected casing 202 are then put into a bonding machine capable of heating and applying pressure to the tire components. This causes the bonding layer or cushion gum to connect the tire tread 102 and the tire casing 104. Once the tire is removed from the bonding machine, it may be installed on the customer's vehicle or otherwise given to the customer.

In preferred embodiments, the final curing step of the manufacturing process (see also, FIG. 3, step 500) at the point-of-sale facility can be accomplished in a short amount of time such that a customer can wait at a point-of-sale as their specific customized tire is prepared. In some embodiments, the curing of the final tire can be accomplished in as little as one hour. In other preferred embodiments, the point-of-sale facilities are under an obligation to the manufacturer of the tire treads and the tire casings to maintain the quality of a tire produced using methods and systems in accordance with principles of the present disclosure.

In other embodiments, the customization system 402 can interface directly with a customer's vehicle and select for a customer the best tire and casing based on past vehicle usage characteristics. In such embodiments, the customization system 402 can include a driving condition obtaining unit that is adapted to obtain the past driving conditions of a user's vehicle. From those driving conditions, the customization system 402 is adapted to select the most appropriate tire tread 102 and tire casing 202 combination for a specific user's driving needs.

In one embodiment, a method for manufacturing tires upon demand at a point-of-sale location includes maintaining a tire casing inventory of a plurality of different types of tire casings at the point-of-sale location. A tire tread inventory of a plurality of different types of tire treads is also maintained at the point-of-sale location. Customer tire selection information is received at the point-of-sale location. The customer tire selection information includes a tire characteristic. In response to receiving the customer information, tire building equipment at the point-of-sale facility is operated to produce from a tread-casing combination of a selected type of the tire treads and a selected type of the tire casing a new tire having the tire characteristic. The tire characteristic can be selected from the group consisting of: rolling resistance, wear resistance, traction capability under different weather and climate conditions, speed rating, and drive-surface-specific features of the tire

In embodiments, at least one type of the tire treads is manufactured by zone curing the tire tread. At least one type of the tire casings can also be manufactured by zone curing the tire casing. The new tire can be produced by buffing a subtread of the tire casing such that the new tire is within a predetermined dimensional tolerance.

In embodiments, a graphical user interface adapted to receive the customer tire selection information can be presented. In response to receiving the customer tire selection information, a listing can be determined which corresponds to tread-casing combinations from the different types of tire casings and the different types of tire treads which produce a tire corresponding to the customer selection information. The listing can be presented in the graphical user interface. A selection indicative of a particular tread-casing combination in the listing can be received, and the new finished tire can be produced using the selected particular tread-casing combination.

In yet other embodiments, a graphical user interface including a list of tire treads corresponding to the different types of tire treads can be presented. A selection can be received from a user of one of the types of tire treads. A list of tire casings corresponding to the different types of tire casings can be displayed in the graphical user interface. A selection can be received from the user of one of the types of tire casings. The new finished tire can be produced using the selected tread type and the selected casing type.

In another embodiment, a method for manufacturing customized tires upon demand at a point-of-sale location includes maintaining a tire casing inventory of a plurality of different types of tire casings at the point-of-sale location. A tire tread inventory of a plurality of different types of tire treads is also maintained at the point-of-sale location. Customer tire selection information including at least one selected rating corresponding to a performance characteristic of a tire is received at the point-of-sale. Based on the at least one selected rating, a particular type of tire casing is selected from the types of tire casings, and a particular type of tire tread is selected from the types of tire treads. A tire is built at the point-of-sale location using a tread-casing combination including a tread of the selected type and a casing of the selected type. In some embodiments, the rating comprises a numerical score on a scale. In embodiments, the tire is built at the point-of-sale location within a predetermined time (e.g., within two hours) from receiving the customer tire selection information.

Using conventional methods of tire manufacturing, tire dealers are required to stock many different types of tires and are required to stock large quantities of such tires. Using methods and systems in accordance with principles of the present disclosure can allow tire dealers to significantly reduce the tire inventory needed to cover the same range of tire types using conventional manufacturing techniques. Tire dealers can sell many different types of completed tires by stocking a much smaller amount of casings and treads. For example, it can be possible that a tire dealer could stock four different types of casings and four different types of compatible treads but be able to sell sixteen different types of tires by mixing and matching the treads and casings.

Additionally, significant savings can result from reducing the amount of old tires that must be destroyed or sold at reduced pricing under conventional tire manufacturing methods. Similar to many food products, vehicle tires only have a certain shelf life in inventory. Using conventional methods of tire manufacturing, tire dealers are required to stock large amounts of tires that they may or may not be able to sell. Using methods and systems in accordance with principles of the present disclosure can allow tire dealers to stock smaller amounts of tire treads and tire casings by being able to fulfill demand from a smaller store of inventory of piece parts through the ability to mix and match treads and casings based on customer preference. Thus, using methods and systems in accordance with principles of the present disclosure can reduce the age of the tire inventory for a point-of-sale facility, as well.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing tires at a point-of-sale facility, said system comprising:
a tire casing inventory of a plurality of different types of tire casings, the tire casing inventory stored at the point-of-sale facility;
a tire tread inventory of a plurality of different types of tire treads, the tire tread inventory stored at the point-of-sale facility;
tire building equipment disposed at the point-of-sale facility and adapted to combine a selected type of the tire casings with a selected type of the tire treads to produce a new finished tire having at least one predetermined tire characteristic.

2. The system for manufacturing tires at a point-of-sale facility of claim 1, wherein said at least one tire characteristic includes at least one of rolling resistance, wear resistance, traction capability under different weather and climate conditions, speed rating, and drive-surface-specific features of the tire.

3. The system for manufacturing tires at a point-of-sale facility of claim 1, further comprising:
a customization system including a physical computer-readable medium having computer-executable instructions stored thereon and a processor adapted to execute said computer-executable instructions to present a graphical user interface adapted to receive customer selection information and to determine a listing corresponding to tread-casing combinations from the different types of tire casings and the different types of tire treads which produce a tire corresponding to the customer selection information.

4. The system for manufacturing tires at a point-of-sale facility of claim 3, wherein the customization selection information includes information regarding at least one tire performance characteristic.

5. The system for manufacturing tires at a point-of-sale facility of claim 3, wherein the customization selection information includes information regarding a selection of at least one of the type of tire tread and the type of tire casing.

6. The system for manufacturing tires at a point-of-sale facility of claim 3, wherein each unique tread-casing combination is designated a particular tire identifier, and the customization system is adapted to display a listing of particular tire identifiers that correspond to the customer selection information in the graphical user interface.

7. The system for manufacturing tires at a point-of-sale facility of claim 6, wherein the customization system includes a data storage device having stored therein inventory information relating to the number of each of the different types of tire casings in the tire casing inventory and the number of each of the different types of tire treads in the tire tread inventory, and the customization system is adapted to display a listing of particular tire identifiers that: (i) correspond to the customer selection information in the graphical user interface, and (ii) include a tire tread in the tire tread inventory and a tire casing in the tire casing inventory at the point-of-sale facility.

8. A method for manufacturing tires upon demand at a point-of-sale location, said method comprising:
maintaining at the point-of-sale location a tire casing inventory of a plurality of different types of tire casings;
maintaining at the point-of-sale location a tire tread inventory of a plurality of different types of tire treads;
receiving customer tire selection information at the point-of-sale location, said customer tire selection information including a tire characteristic;
in response to receiving the customer information, operating tire building equipment at the point-of-sale location to produce from a tread-casing combination of a selected type of the tire treads and a selected type of the tire casing a new tire having the tire characteristic.

9. The method for manufacturing tires upon demand at a point-of-sale location of claim 8, further comprising:
manufacturing at least one type of the tire treads by zone curing the tire tread.

10. The method for manufacturing tires upon demand at a point-of-sale location of claim 9, further comprising:
manufacturing at least one type of the tire casings by zone curing the tire casing.

11. The method for manufacturing tires upon demand at a point-of-sale location of claim 8, further comprising:
manufacturing at least one type of the tire casings by zone curing the tire casing.

12. The method for manufacturing tires upon demand at a point-of-sale location of claim 8, wherein producing the new tire includes buffing a subtread of the tire casing such that the new tire is within a predetermined dimensional tolerance.

13. The method for manufacturing tires upon demand at a point-of-sale location of claim 8, wherein the tire characteristic is selected from the group consisting of: rolling resistance, wear resistance, traction capability under different weather and climate conditions, speed rating, and drive-surface-specific features of the tire.

14. The method for manufacturing tires upon demand at a point-of-sale location of claim 8, further comprising:
presenting a graphical user interface adapted to receive the customer tire selection information.

15. The method for manufacturing tires upon demand at a point-of-sale location of claim 14, further comprising:
in response to receiving the customer tire selection information, determining a listing corresponding to tread-casing combinations from the different types of tire casings and the different types of tire treads which produce a tire corresponding to the customer selection information.

16. The method for manufacturing tires upon demand at a point-of-sale location of claim 15, further comprising:
receiving a selection indicative of a particular tread-casing combination in the listing and producing the new finished tire using said particular tread-casing combination.

17. The method of claim 8, further comprising the steps of:
presenting a graphical user interface including a list of tire treads corresponding to the different types of tire treads;
receiving a selection from a user of one of the types of tire treads;
displaying on the graphical user interface a list of tire casings corresponding to the different types of tire casings; and
receiving a selection from the user of one of the types of tire casings;
producing the new finished tire using said selected tread type and said selected casing type.

18. A method for manufacturing customized tires upon demand at a point-of-sale location, said method comprising:
maintaining at the point-of-sale location a plurality of types of tire casings;
maintaining at the point-of-sale location a plurality of types of tire treads;
receiving at the point-of-sale customer tire selection information including at least one selected rating corresponding to a performance characteristic of a tire;
based on the at least one selected rating, selecting a particular type of tire casing from the types of tire casings and selecting a particular type of tire tread from the types of tire treads; and,
building a tire at the point-of-sale location using a tread-casing combination including a tread of the selected type and a casing of the selected type.

19. The method for manufacturing customized tires upon demand at a point-of-sale location of claim 18, wherein the tire is built at the point-of-sale location within a predetermined time from receiving the customer tire selection information.

20. The method for manufacturing customized tires upon demand at a point-of-sale location of claim 18, wherein the rating comprises a numerical score on a scale.
